(19) United States
(12) Patent Application Publication
(10) Pub. No.: US 2017/0017394 A1
(43) Pub. Date: Jan. 19, 2017

(54) SYSTEM AND METHOD FOR DATA WAREHOUSE AND FINE GRANULARITY SCHEDULING FOR SYSTEM ON CHIP (SoC)

(71) Applicant: Futurewei Technologies, Inc., Plano, TX (US)

(72) Inventors: Yan Wang, Plano, TX (US); Alan Gatherer, Richardson, TX (US)

(21) Appl. No.: 14/800,354

(22) Filed: Jul. 15, 2015

(51) Int. Cl. G06F 3/06

(52) U.S. Cl. CPC G06F 3/061; G06F 3/0658; G06F 3/0673

(57) ABSTRACT

A data warehouse includes a memory and a controller disposed on a substrate that is associated with a System on Chip (SoC). The controller is operatively coupled to the memory. The controller is configured to receive data from a first intellectual property (IP) block executing on the SoC; store the data in the memory on the substrate; and in response to a trigger condition, output at least a portion of the stored data to the SoC for use by a second IP block. An organization scheme for the stored data in the memory is abstracted with respect to the first and second IP blocks.

### TECHNICAL FIELD

The present disclosure relates generally to data storage, and more particularly, to a system and method for data warehouse and fine granularity scheduling for a System on Chip.

### BACKGROUND

System on Chip (SoC) bulk memory (e.g., Level 3 (L3) RAM) and off-chip memory (e.g., double data rate (DDR) memory) found in most wireless communication devices is often used very inefficiently, with much of the memory sitting idle with old data that will not be reused, or storing data that is double- or triple-buffered to simplify processing access to tables and arrays. This can lead to significant waste of power and chip physical area. Some existing technologies employ a simple global memory map of all available bulk memory and software organization of data, such as static mapping. Hand optimization of memory usage via “overlays” of data is employed in some real time embedded systems; however, such techniques are difficult and time consuming to create, and have poor code reuse properties. Some Big Data servers employ various memory management techniques in file servers; however, these techniques are usually complicated and have large overhead requirements that make the techniques not suitable for SoC.

### SUMMARY

According to one embodiment, there is provided a data warehouse. The data warehouse includes a memory and a controller disposed on a substrate that is associated with a System on Chip (SoC). The controller is operatively coupled to the memory. The controller is configured to receive data from a first intellectual property (IP) block executing on the SoC; store the data in the memory; and in response to a trigger condition, output at least a portion of the stored data to the SoC for use by a second IP block. An organization scheme for the stored data in the memory is abstracted with respect to the first and second IP blocks.

According to another embodiment, there is provided a method. The method includes receiving, by a controller of a data warehouse, data from a first IP block executing on a SoC, the controller disposed on a substrate, the substrate different than the SoC. The method also includes storing, by the controller, the data in a memory disposed on the substrate, the memory operatively coupled to the controller. The method further includes, in response to a trigger condition, outputting, by the controller, at least a portion of the stored data to the SoC for use by a second IP block. An organization scheme for the stored data in the memory is abstracted with respect to the first and second IP blocks.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example communication system that that may be used for implementing the devices and methods disclosed herein;

FIGS. 2A and 2B illustrate example devices that may implement the methods and teachings according to this disclosure;

FIG. 3 illustrates one example of a SoC architecture capable of supporting a LTE system;

FIGS. 4A through 4C illustrate example data storage schemes for storing data in DDR memory in accordance with this disclosure;

FIGS. 5A and 5B illustrate two example schemes for organizing data storage boxes hierarchically using user tables, in accordance with this disclosure;

FIG. 6 illustrates an example of fine granularity scheduling using a data warehouse in accordance with this disclosure;

FIGS. 7A and 7B illustrate additional details of fine granularity scheduling, in accordance with this disclosure; and

FIG. 8 illustrates an example data warehouse architecture in accordance with this disclosure.

### DETAILED DESCRIPTION

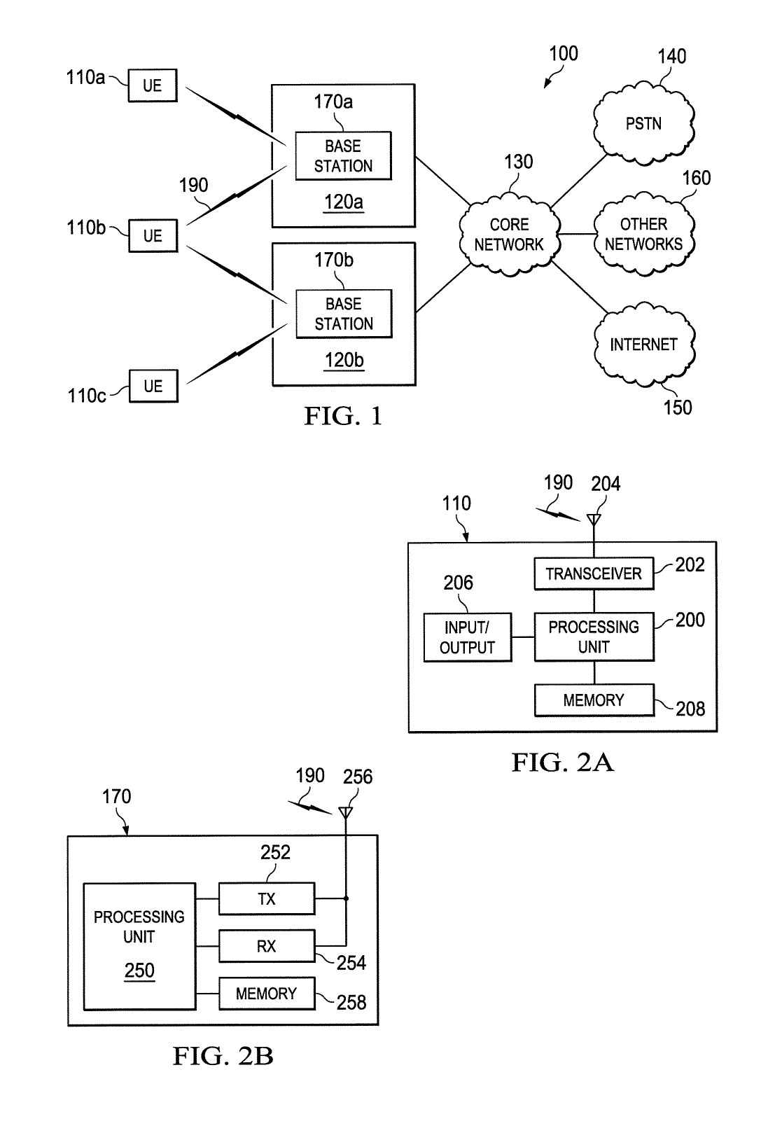

FIGS. 1 through 8, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

To facilitate understanding of this disclosure, it may be helpful to distinguish between ‘memory’ and ‘storage’, as the terms are used herein. Memory is a physical construct that has no associated semantics. That is, memory has no awareness of what data is stored in it. Memory may be used by multiple different software applications for storage of data. In contrast, storage is associated with indicators, pointers, labels, and the like, that provide context for the storage, including relationships between memory addresses, etc.

In current systems that utilize System on Chip (SoC) technology, data that is not going to be used for a while may not be stored on-chip, but instead may be stored off-chip in long term DDR memory. However, some systems are beginning to encounter significant challenges in terms of DDR memory access. There are at least two factors driving this. A first factor is the physical analog interface from the SoC chip to the DDR memory. Although SoC chips continue to improve according to Moore's law, there has not been a similar improvement to the analog interface to the DDR memory. Thus, the interface is becoming more and more of a bottleneck. A second factor is that, in some systems, many masters on the SoC drive access to the DDR memory (which acts as a slave component to the different masters). That is, there may be a large number of different IP (intellectual property) blocks with software components (e.g., software applications), hardware components, or both, that need to store data in the DDR memory or retrieve data from it. In many systems, these IP blocks do not work together to have a coordinated access scheme. Each IP block may carve out oversized sections of the DDR memory, which leads to unused or inefficiently used memory. Also, the pattern in which the IP blocks access memory is uncoordinated and may lead to bursts of heavy data access and periods of no access. This is an inefficient use of the limited DDR access bandwidth.

The present disclosure describes many technical advantages over conventional memory management techniques. For example, one technical advantage is memory management and processing that is performed close to the DDR memory itself. Another technical advantage is simplified digital signal processor (DSP) access to the DDR memory. Another technical advantage is efficient bulk storage that includes lower overhead in the memory access. Another technical advantage is better code reusability at the software application level, due to the local management of data at the DDR memory. And another technical advantage is the ability of simple hardware accelerators (HACs) to access complex data structures stored in the DDR memory.

FIG. 1 illustrates an example communication system 100 that may be used for implementing the devices and methods disclosed herein. In general, the system 100 enables multiple wireless users to transmit and receive data and other content. The system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless links such as communication links 190.

In this example, the communication system 100 includes user equipment (UE) 110a-110c, radio access networks (RANs) 120a-120b, a core network 130, a public switched telephone network (PSTN) 140, the Internet 150, and other networks 160. While certain numbers of these components or elements are shown in FIG. 1, any number of these components or elements may be included in the system 100. In some embodiments, only wireline networking links are used.

The UEs 110a-110c are configured to operate and/or communicate in the system 100. For example, the UEs 110a-110c are configured to transmit and/or receive wireless signals or wired signals. Each UE 110a-110c represents any suitable end user device and may include such devices (or may be referred to) as a user equipment/device (UE), wireless transmit/receive unit (WTRU), mobile station, fixed or mobile subscriber unit, pager, cellular telephone, personal digital assistant (PDA), smartphone, laptop, computer, touchpad, wireless sensor, or consumer electronics device.

The RANs 120a-120b here include base stations 170a-170b, respectively. Each base station 170a-170b is configured to wirelessly interface with one or more of the UEs 110a-110c to enable access to the core network 130, the PSTN 140, the Internet 150, and/or the other networks 160. For example, the base stations 170a-170b may include (or be) one or more of several well-known devices, such as a base transceiver station (BTS), a Node-B (NodeB), an evolved NodeB (eNodeB), a Home NodeB, a Home eNodeB, a site controller, an access point (AP), or a wireless router, or a server, router, switch, or other processing entity with a wired or wireless network.

In the embodiment shown in FIG. 1, the base station 170a forms part of the RAN 120a, which may include other base stations, elements, and/or devices. Also, the base station 170b forms part of the RAN 120b, which may include other base stations, elements, and/or devices. Each base station 170a-170b operates to transmit and/or receive wireless signals within a particular geographic region or area, sometimes referred to as a “cell.” In some embodiments, multiple-input multiple-output (MIMO) technology may be employed having multiple transceivers for each cell.

The base stations 170a-170b communicate with one or more of the UEs 110a-110c over one or more air interfaces 190 using wireless communication links. The air interfaces 190 may utilize any suitable radio access technology.

It is contemplated that the system 100 may use multiple channel access functionality, including such schemes as described above. In particular embodiments, the base stations and UEs may implement LTE, LTE-A, and/or LTE-B. Of course, other multiple access schemes and wireless protocols may be utilized.

The RANs 120a-120b are in communication with the core network 130 to provide the UEs 110a-110c with voice, data, application, Voice over Internet Protocol (VoIP), or other services. Understandably, the RANs 120a-120b and/or the core network 130 may be in direct or indirect communication with one or more other RANs (not shown). The core network 130 may also serve as a gateway access for other networks (such as PSTN 140, Internet 150, and other networks 160). In addition, some or all of the UEs 110a-110c may include functionality for communicating with different wireless networks over different wireless links using different wireless technologies and/or protocols.

Although FIG. 1 illustrates one example of a communication system, various changes may be made to FIG. 1. For example, the communication system 100 could include any number of UEs, base stations, networks, or other components in any suitable configuration.

FIGS. 2A and 2B illustrate example devices that may implement the methods and teachings according to this disclosure. In particular, FIG. 2A illustrates an example UE 110 and FIG. 2B illustrates an example base station 170. These components could be used in the system 100, or in any other suitable system. In particular, these components could be configured for data warehouse and fine granularity scheduling, as described herein.

As shown in FIG. 2A, the UE 110 includes at least one processing unit 200. The processing unit 200 implements various processing operations of the UE 110. For example, the processing unit 200 could perform signal coding, data processing, power control, input/output processing, or any other functionality enabling the UE 110 to operate in the system 100. The processing unit 200 also supports the methods and teachings described in more detail above. Each processing unit 200 includes any suitable processing or computing device configured to perform one or more operations. One or more processing units 200 could, for example, include a microprocessor, microcontroller, digital signal processor, field programmable gate array, system on chip (SoC), or application specific integrated circuit.

The UE 110 also includes at least one transceiver 202. The transceiver 202 is configured to modulate data or other content for transmission by at least one antenna 204. The transceiver 202 is also configured to demodulate data or other content received by the at least one antenna 204. Each transceiver 202 includes any suitable structure for generating signals for wireless transmission and/or processing signals received wirelessly. Each antenna 204 includes any suitable structure for transmitting and/or receiving wireless signals. One or multiple transceivers 202 could be used in the UE 110, and one or multiple antennas 204 could be used in the UE 110. Although shown as a single functional unit, a transceiver 202 could also be implemented using at least one transmitter and at least one separate receiver.

The UE 110 further includes one or more input/output devices 206. The input/output devices 206 facilitate interaction with a user. Each input/output device 206 includes any suitable structure for providing information to or receiving information from a user, such as a speaker, microphone, keypad, keyboard, display, or touch screen.

In addition, the UE 110 includes at least one memory 208. The memory 208 stores instructions and data used, generated, or collected by the UE 110. For example, the memory 208 could store software or firmware instructions executed by the processing unit(s) 200 and data used by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like. In accordance with the embodiments described herein, the memory 208 may comprise DDR memory, L3 memory, any other suitable memory, or a combination of two or more of these. Together, the memory 208 and at least one processing unit 200 could be implemented as a data warehouse, as described in greater detail below. The memory 208 and the at least one processing unit 200 associated with the data warehouse may be disposed in close proximity on a substrate, such as a chip. In particular embodiments, the memory 208 and the at least one processing unit 200 associated with the data warehouse may be part of the SoC.

As shown in FIG. 2B, the base station 170 includes at least one processing unit 250, at least one transmitter 252, at least one receiver 254, one or more antennas 256, and at least one memory 258. The processing unit 250 implements various processing operations of the base station 170, such as signal coding, data processing, power control, input/output processing, or any other functionality. The processing unit 250 can also support the methods and teachings described in more detail above. Each processing unit 250 includes any suitable processing or computing device configured to perform one or more operations. One or more processing units 250 could, for example, include a microprocessor, microcontroller, digital signal processor, field programmable gate array, system on chip (SoC), or application specific integrated circuit.

Each transmitter 252 includes any suitable structure for generating signals for wireless transmission to one or more UEs or other devices. Each receiver 254 includes any suitable structure for processing signals received wirelessly from one or more UEs or other devices. Although shown as separate components, at least one transmitter 252 and at least one receiver 254 could be combined into a transceiver. Each antenna 256 includes any suitable structure for transmitting and/or receiving wireless signals. While a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s). In accordance with the embodiments described herein, each memory 258 may comprise DDR memory, L3 memory, bulk on-chip memory, any other suitable memory, or a combination of two or more of these. Together, the memory 258 and at least one processing unit 250 could be implemented as a data warehouse, as described in greater detail below. The memory 258 and the at least one processing unit 250 associated with the data warehouse may be disposed in close proximity on a substrate, such as a chip. In particular embodiments, the memory 258 and the at least one processing unit 250 associated with the data warehouse may be part of the SoC.

Additional details regarding the UEs 110 and the base stations 170 are known to those of skill in the art. As such, these details are omitted here. It should be appreciated that the devices illustrated in FIGS. 2A and 2B are merely examples, and are not intended to be limiting. Various embodiments of this disclosure may be implemented using one or more computing devices that include the components of the UEs 110 and base stations 170, or which include an alternate combination of components, including components that are not shown in FIGS. 2A and 2B. For example, various embodiments of this disclosure may be implemented using a multi-processor computer, a plurality of single and/or multiprocessor computers arranged into a network, or some combination of both.

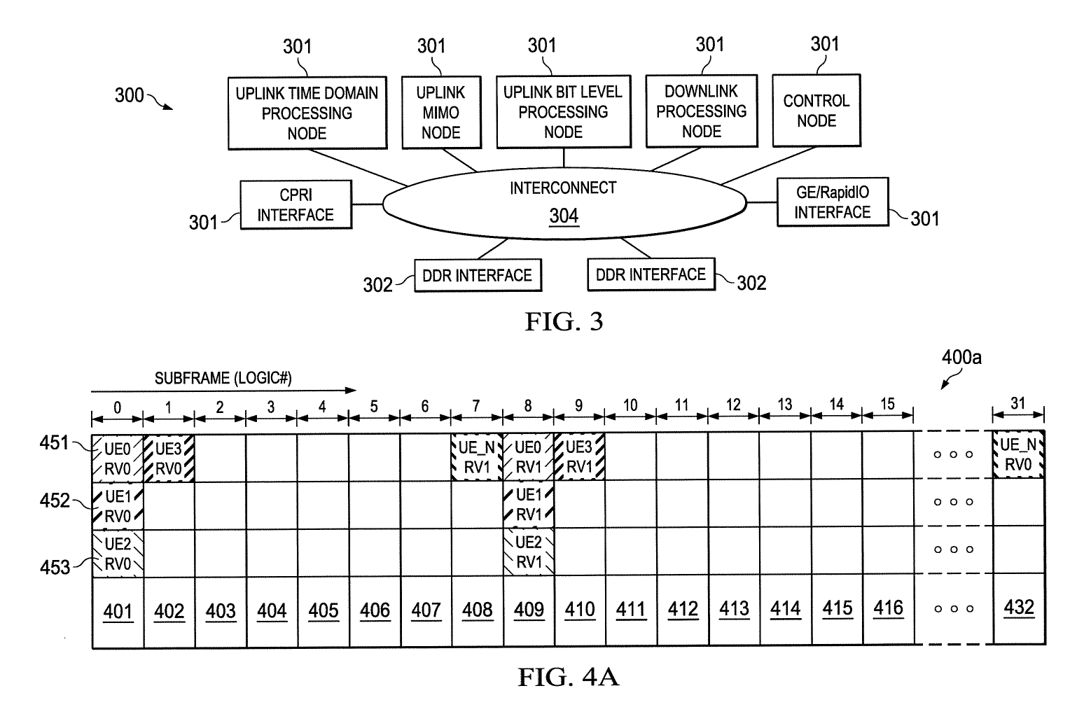

FIG. 3 illustrates one example of a SoC architecture capable of supporting a LTE system, such as the system 100 of FIG. 1. The architecture 300 can be employed in a number of system components, such as the UEs 110 and the base stations 170.

As shown in FIG. 3, the architecture 300 includes a plurality nodes, including data masters 301 that are connected to one or more logical DDR interfaces 302 through a data interconnect 304. Uplink reception and downlink transmission can be supported by mapping different functions to the different nodes, as known in the art. Each data master 301 may represent an IP block or other processing unit configured to use or process data that can be stored in a DDR memory module, such as the memory 208, 258. Each logical DDR interface 302 provides an interface to a DDR memory module. Each DDR memory module can be used to store various data for used by one or more of the data masters 301. In some embodiments, the data may be associated with LTE communication, including Hybrid Automatic Repeat Request (HARQ) retransmission data, measurement reports, Physical Uplink Shared Channel (PUSCH) HARQ data, and pre-calculated reference signal (RS) sequences for Physical Random Access Channel (PRACH) and beamforming covariance matrix and weight vectors. Control information, like task lists, parameter tables, hardware accelerator (HAC) parameters, and UE information tables can also be stored in DDR memory. The logical DDR interfaces 302 can include a number of different types of DDR interfaces, including a HARQ DDR interface, a RS sequence DDR interface, and the like. The logical DDR interfaces 302 could be physically located in one DDR interface.

Data in DDR memory (e.g., data arrays, buffers, tables, etc.) is generally moved around the system in bulk, moving from processing to storage and back. There are common aspects for some of the DDR data movements when considered from the point of view of the physical (PHY) layer. Typically, the data will not be changed, i.e., the data will be read out of memory the same as it is written into memory. The total amount of data to be stored is large, and the stored data has a same or similar type or data structure (e.g., usually the data is separated by “user” or UE). Typically, there are few or no real-time requirements; every time the memory is accessed, only a small part of the data is visited, either by request (i.e., event driven) or periodically. If the data is fetched by request, typically it is known in advance when the data is needed (e.g., through MAC/RRC, it is known which user's data will be needed for the next one or several subframes).

From the description above, it can be seen that there are similarities between DDR memory access and how a commercial or industrial warehouse operates. The “goods” (i.e., data) are shipped from many sources to a “warehouse” (i.e., DDR memory) for storage and are packed in “boxes” (i.e., data blocks or data records). The warehouse may have multiple “floors” (i.e., subframes) or one floor. In each floor, the boxes are organized in different “rows” (i.e., users/UEs, or certain processes of a user/UE). Whenever the goods are packed in the boxes and put in the warehouse, the locations of the boxes are tracked in a warehouse inventory log (e.g., a register).

In a warehouse, it is generally known when the boxes will be moved or sent to their destination. However, the sender and receiver generally do not know the exact location of their box in the warehouse. They may have a tracking label that is used to store and find the box by a warehouse management system.

Likewise, data in DDR memory can be stored and tracked using a “data warehouse” correlation. Data blocks (e.g., data arrays, buffers, tables, etc., which are analogous to warehouse “boxes”) come in different sizes and are stored as a unit in the memory (“warehouse”) by the data warehouse management system. Each data block is given a tracking number for retrieval purposes. The time to move (i.e., output) data in DDR memory is predictable, e.g., either by request from an IP block, periodically according to a schedule, or in response to another trigger condition, such as back pressure, or a lack of space in the memory to store new received data. With the help of the register, the data can be pre-arranged and output in advance. For example, the data from different users can be packed, arranged, or assembled beforehand, and the pre-arranged data can be delivered to the “consumer” (e.g., an IP block or software application that uses the data) in advance or at a designated time. Since the required data is pre-arranged in the DDR memory module and there are few interactions between the DDR memory module and other cluster nodes, the efficiencies are higher, both from the perspective of cluster node scheduling and of transmission (e.g., the data is transmitted in burst). Thus, a “data warehouse” parallel can be used for DDR memory access.

In accordance with the above description, embodiments of this disclosure provide systems and methods to abstract the storage and retrieval of data (“data warehousing”). The disclosed embodiments also allow large blocks to be automatically split up during transport to minimize double buffering overhead (“fine granularity scheduling”). By using the “data warehouse” concept, the digital signal processor (DSP) is less involved in the data movements from the DDR to the DSP cluster. Furthermore, the data is managed locally in the DDR interface instead of at the DSP. Data is already “pushed” to the DSP cluster memory when the DSP cluster is ready to process the data.

Certain embodiments can include hardware that is physically connected close to the DDR, and so the access latency to the DDR is small. The embodiments provide a single, centralized point of organization and management that all data masters can go through to access data in the DDR. In certain embodiments, the system scheduler (e.g., the MAC scheduler) may know when data needs to be moved in advance and can retrieve the data into a “holding area” of memory close to the DDR interface for rapid retrieval.

The disclosed embodiments are described with respect to at least two components: a controller and the DDR memory. The controller interfaces with the SoC architecture. In particular, the controller and the DDR memory may be disposed on the same substrate, which may include the SoC. In other embodiments, the controller and the DDR memory may be disposed on a substrate (e.g., a chip) that is separate from the SoC. The controller performs operations such as sending and receiving FLITs (flow control digits), segmenting packets into FLITs, and preparing a header for each FLIT. The controller is also responsible for operations such as generating and terminating back pressure credit messages, and user management functions.

Although the disclosed embodiments are described primarily with respect to a LTE system, it will be understood that these embodiments can also be applied to a UMTS (Universal Mobile Telecommunications System) system. Likewise, while the disclosed embodiments are described primarily with respect to SoC architecture, the systems and methods of the disclosed embodiments are also applicable for other architectures.

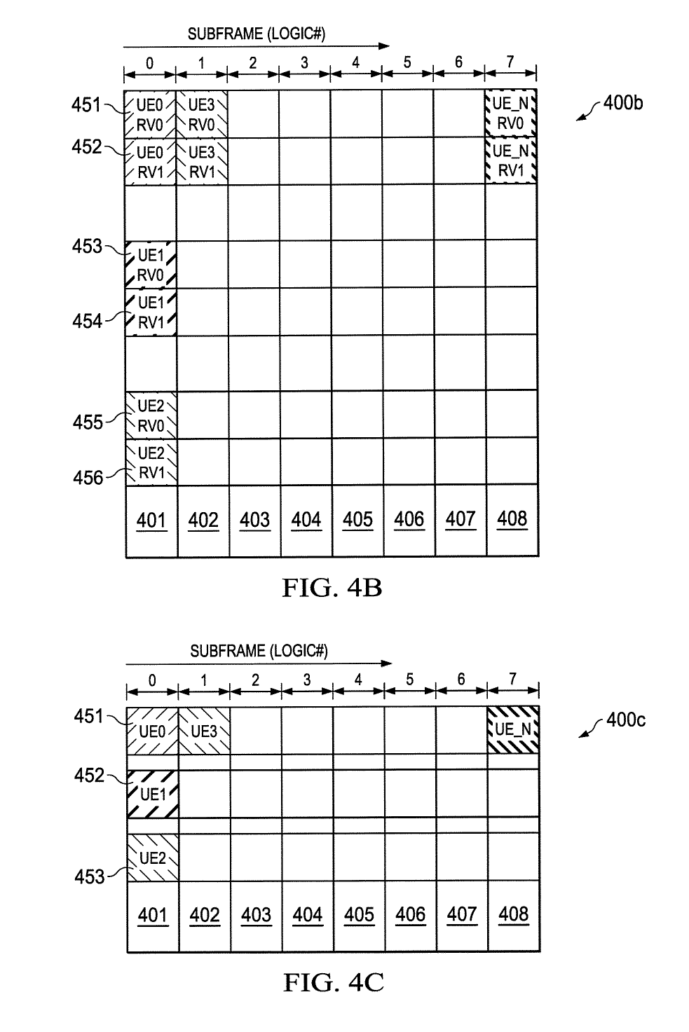

Before the description of how data is managed, it is helpful to first describe how data can be stored in a data warehouse in DDR memory. FIGS. 4A through 4C illustrate example data storage schemes for storing data in DDR memory in accordance with this disclosure. In the examples shown in FIGS. 4A through 4C, the data is associated with a system that uses Hybrid Automatic Repeat Request (HARQ) error control. Of course, in other embodiments, the data could be associated with any other suitable system.

In FIGS. 4A through 4C, the data is stored in “boxes” on 8 or 32 “floors” (columns) 401-432, where each floor represents one of the subframes #0˜#31 in the HARQ communication. Each column 401-432 is arranged by “rows” (illustrated by example rows 451-456), where each row represents data for one of the users UE0-UE_N. Boxes can be added (i.e., allocated), taken away (i.e., freed), or refilled (i.e., rewritten). In FIGS. 4A through 4C, each subframe column 401-432 can be a linked list. The data may include metadata to maintain the relationship between the data in each column.

Since UL HARQ is synchronous, the redundancy version (RV) data can be packed in advance and “pushed out” in a synchronized fashion. There are two options for using the retransmission data: (1) keep all the RV data, or (2) only keep the combined data. For Option 1, the data from all the redundancy versions will be used for HARQ combination and decoding (e.g., incremental redundancy, or ‘IR’). That is, every time that the HARQ data is needed from the DDR memory, all of the RV data stored will be output. Different methods for storing all RV data for Option 1 are shown in FIGS. 4A and 4B. For Option 2, only the combined data is kept in the DDR memory whenever there is a retransmission (e.g., chase combining or IR, etc.). FIG. 4C shows a method storing only combined data for Option 2.

Option 1: Keep All RV Data

FIGS. 4A and 4B illustrate two different data storage schemes 400a-400b for storing the RV data in a data warehouse in the DDR memory module. In the data storage scheme 400a in FIG. 4A, the data is stored by the number of the subframe in which the data arrived. It is assumed that each HARQ process can have up to four retransmissions (of eight subframes each), resulting in a total of 32 subframes 401-432. The data is stored according to the subframe number (or logic number) in which it arrived. Only one HARQ process per UE is illustrated here. UE0 has a first transmission RV0 on subframe 401 (#0), and a second retransmission RV1 on subframe 409 (#8), etc. It can be seen that once the data exceeds subframe 432 (#31), the selection of the subframe for storage can be wrapped around and started from subframe 401 again. For example for UE_N, the first transmission RV0 is on subframe 432 (#31) and the second retransmission RV1 is on subframe 408 (#7). In some embodiments, the 8 ms timing associated with HARQ is always used.

In the data storage scheme 400b in FIG. 4B, the data is stored by the number of the subframe of first arrival for a given user. Logically, only eight subframes 401-408 are maintained in the data warehouse. For example, if the first transmission RV0 of UE0 occurs at subframe 401 (#0), then all of the RV data (e.g., RV0, RV1, RV2, etc.) for UE0 will be stored in subframe 401 (#0). As shown in FIG. 4B, all of the RV data for a particular UE is stored contiguously. For example, the RV0 and RV1 data for UE0 are stored in contiguous rows 451-452, the RV0 and RV1 data for UE1 are stored in contiguous rows 453-454, and the RV0 and RV1 data for UE2 are stored in contiguous rows 455-456. The data storage scheme 400b may require additional pointers as compared to the data storage scheme 400a, and may take longer to allocate and store the data. However, the data storage scheme 400b should enable a faster retrieval time of data for a user because all of a user's data is stored together.

The data storage schemes 400a-400b have the same or similar memory requirements. Considered from the point of view of timing, the data storage scheme 400a is very straightforward. However, the data storage scheme 400b may have a smaller user list and time table, and thus be easier to manage. In some embodiments, if all RV data is kept, the storage scheme used by the data storage scheme 400b may be advantageous for the HARQ DDR storage.

Option 2: Keep Only Combined Data

It may also be possible that only the combined RV data is stored (for example, in chase combining or IR). In FIG. 4C, the data storage scheme 400c stores data by subframe number of first arrival. For example, the initial transmission of combined data for UE0 is stored in subframe 401 (#0). Then, any new combined data is stored by overwriting the old combined data or initial transmission. The data arrangement shown in FIG. 4C is a much simpler scheme; only one “copy” of the data is stored for each UE.

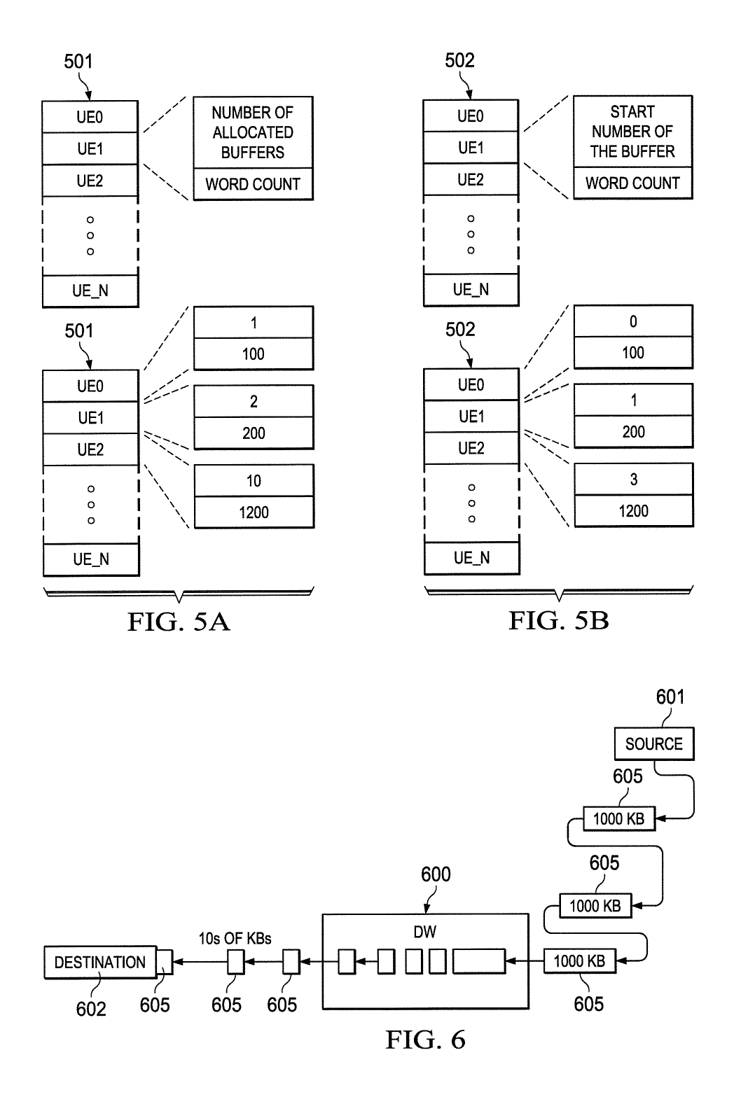

FIGS. 5A and 5B illustrate two example schemes for organizing data storage boxes in a data warehouse hierarchically using user tables, in accordance with this disclosure. The schemes shown in FIGS. 5A and 5B are described below with respect to storage of HARQ data, such as the data described in FIGS. 4A through 4C. However, the organization schemes shown in FIGS. 5A and 5B could be used for any other suitable type of data. As shown in the figures, the data warehouse organizes boxes of data by lists. In some embodiments, an identifier associated with a UE can be selected as the top-level label for a list. However, this is merely one example. Other embodiments may use other labels and other hierarchies.

As described above with respect to FIGS. 4A through 4C, the HARQ DDR memories in FIGS. 5A and 5B can be divided into eight memory blocks, each memory block corresponding to one subframe of HARQ data. Each memory block can include multiple smaller buffers (small boxes) and each buffer can have the same size. When the data is written to the DDR module, the data warehouse uses the register to determine how many buffers to allocate to each user, determine where to put the data in the DDR memory, and create a user table based on the allocations. For example, FIG. 5A illustrates user table 501 and FIG. 5B illustrates user table 502. In the user table 501, the number of allocated buffers and the word count for each user are stored and can be used to find the stored data location. In the user table 502, the start number of the buffer and the word count are stored and can be used to find the stored data location. Since the data buffers are allocated continuously, both methods can be used to directly find the memory location for each UE.

In one aspect of operation, the data warehouse first determines the size of the data to be stored. Based on the data size, the data warehouse can determine how many buffers are needed for each UE. For example, in one embodiment, 128 bytes are chosen for the buffer size. Of course, in other embodiments, the buffer size can be larger or smaller, depending on system configuration. It is assumed that 100 bytes are to be stored for UE0, 200 bytes are to be stored for UE1, and 1200 bytes are to be stored for UE2. Based on a 128-byte buffer size, the stored data will use 1, 2, and 10 buffers, respectively. Thus, the data warehouse allocates one buffer (buffer 0) to UE0; two buffers (buffers 1 and 2) to UE1, and ten buffers (buffers 3 through 12) for UE2. Based on the allocated buffers, the data warehouse will create the user table 501 or the user table 502. The user table 501 includes the number of allocated buffers (i.e., 1, 2, or 10) for each UE. In contrast, the user table 502 includes the buffer number of the starting buffer (i.e., 0, 1, or 3) for each UE. Each user table 501-502 also includes the word count for each user.

The data and the user table 501-502 can be stored for eight subframes. At the seventh subframe (or the beginning of the eighth subframe), the data warehouse can send out the data for the first subframe. Based on the user table of the first subframe, the data warehouse can pre-arrange the data for the first subframe and send out the data to the DSP cluster. Once the data is sent out, the user table 501-502 and the data in the DDR memory will not be used anymore. After the DSP cluster processes the HARQ data and writes the new HARQ data to the DDR memory, the data warehouse can overwrite the old data, and create a new user table for the current subframe.

FIG. 6 illustrates an example of fine granularity scheduling using a data warehouse in accordance with this disclosure. As shown in FIG. 6, a data warehouse 600 is coupled to a data source 601 and a data destination 602. The data source 601 processes data 605 that is intended for use by the destination 602. The data source 601 may represent any suitable IP block or application that processes data. The destination 602 may represent Level 2 (L2) or HAC local memory. The data warehouse 600 may include DDR memory, such as described above.

In some systems, the data source 601 and destination 602 use data in different quantities. For example, the data source 601 may create the data 605 for the destination 602 in 1000-kilobyte blocks. However, the destination 602 may consume and process the data 605 in smaller-sized blocks (e.g., tens of kilobytes). Thus, the data warehouse 600 can receive and store the large blocks of data 605 from the data source 601, and then provide the data 605 in smaller blocks to the destination 602. In particular, the data source 601 may send the data 605 to the data warehouse 600 as complete “boxes” including 1000 KB of data 605. The data warehouse 600 sets up each box for fine granularity scheduling during storage. Later, upon receipt of a request for data 605 for the destination 602, the data warehouse 600 divides or separates a 1000 KB box of data into smaller boxes (e.g., tens of kilobytes), and sends one or more of the smaller boxes to the destination 602.

Thus, the data warehouse 600 abstracts the source 601 and destination 602 with respect to each other, and provides a data “interface” between the source 601 and destination 602, which may not be compatible for communication directly with each other. This can reduce buffering in the DSP cluster and the HAC dramatically.

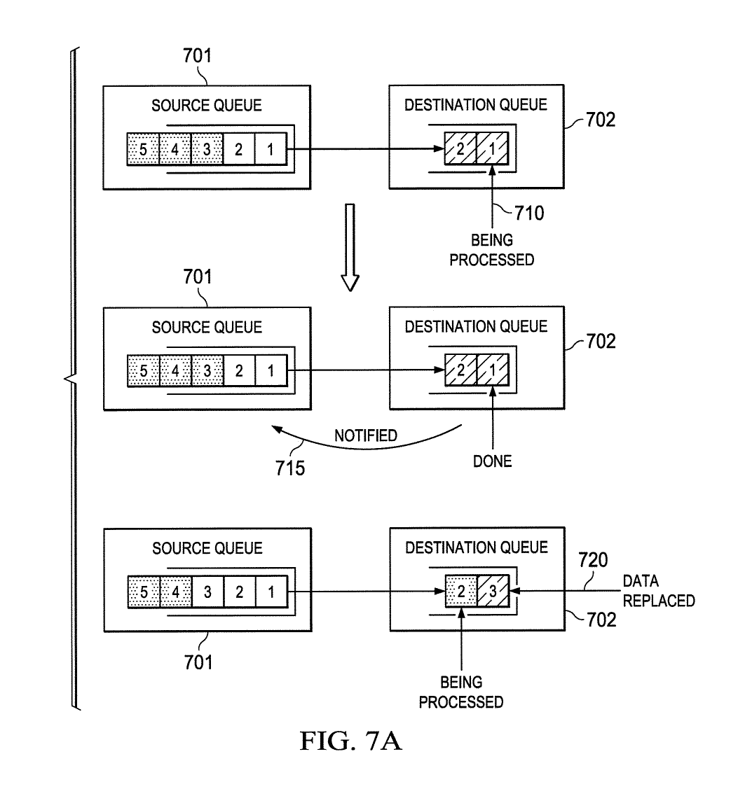

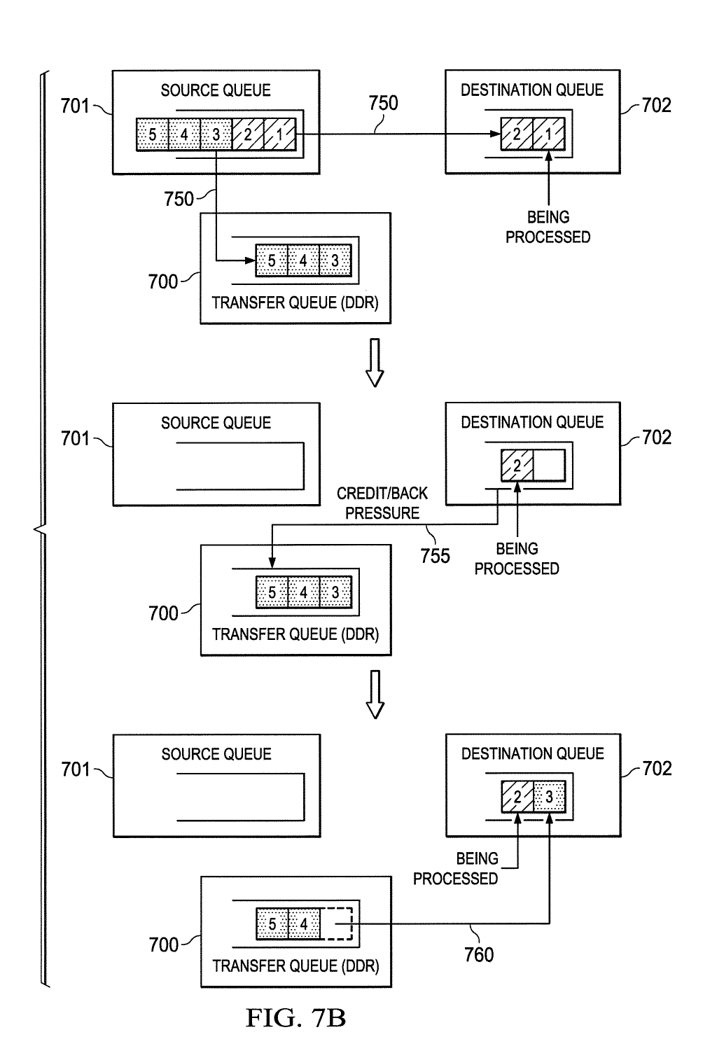

FIGS. 7A and 7B illustrate additional details of fine granularity scheduling, in accordance with this disclosure. As shown in FIGS. 7A and 7B, a source queue 701 processes data that is intended for use at a destination queue 702. The source queue 701 may represent the data source 601 of FIG. 6, and the destination queue 702 may represent the data destination 602 of FIG. 6. In particular, the source queue 701 and destination queue 702 may represent L2 memory that is used by one or more IP blocks (e.g., a software application). Of course, the source queue 701 and destination queue 702 may represent any other suitable data queues. In some embodiments, the source queue 701 and destination queue 702 are disposed inside the SoC.

In FIG. 7A, the destination queue 702 includes a ping pong buffer for use in a DSP cluster or HAC cluster. The ping-pong buffer can be used to hold the data in L2 memory. The source queue 701 includes data blocks 1 through 5 that are intended for the destination queue 702. At 710, the destination queue 702 receives data blocks 1 and 2 and begins processing data block 1. A back pressure or credit mechanism can ensure that the source queue 701 does not transfer more data to the destination queue 702 than the destination queue 702 can process. When the data of data block 1 is consumed in the ping-pong buffer, the buffer is released and the source queue 701 is notified that there is a buffer available at the destination queue 702, as indicated at 715. The notification can be performed by a back pressure or credit mechanism. Then, new data from data block 3 (which is the next data block in the source queue 701) is sent to the ping-pong buffer and replaces the consumed data of data block 1, as indicated at 720.

In FIG. 7A, all of the data is stored in either the source queue 701 or the destination queue 702. However, it some systems, some data may not be used for a long time, and there may be no reason to store the data all of the time in the source queue 701 or the destination queue 702.

In FIG. 7B, some of the data can be moved off-chip into a transfer queue 700. The transfer queue 700 is disposed in DDR memory, which is outside of the SoC chip. The transfer queue 700 acts as a data warehouse, such as the data warehouse 600 of FIG. 6. Similar to FIG. 7A, the source queue 701 includes data blocks 1 through 5 that are intended for the destination queue 702. At 750, the destination queue 702 receives data blocks 1 and 2 and begins to process data block 1 in the ping-pong buffer, while the transfer queue 700 receives the remaining data blocks 3, 4, and 5 from the source queue 701. At that point, the source queue 701 is empty, and is free for other data processing. When the data of data block 1 is consumed in the ping-pong buffer, the buffer is released and the transfer queue 700 is notified that there is a buffer available at the destination queue 702, as indicated at 755. The notification can be performed by a back pressure or credit mechanism. Then, new data from data block 3 (which is the next data block in the transfer queue 700) is sent from the DDR memory to the ping-pong buffer and replaces the consumed data of data block 1, as indicated at 760. The message redirect between the DSP clusters or HAC clusters at the source queue 701 and the destination queue 702 is transparent to the master applications.

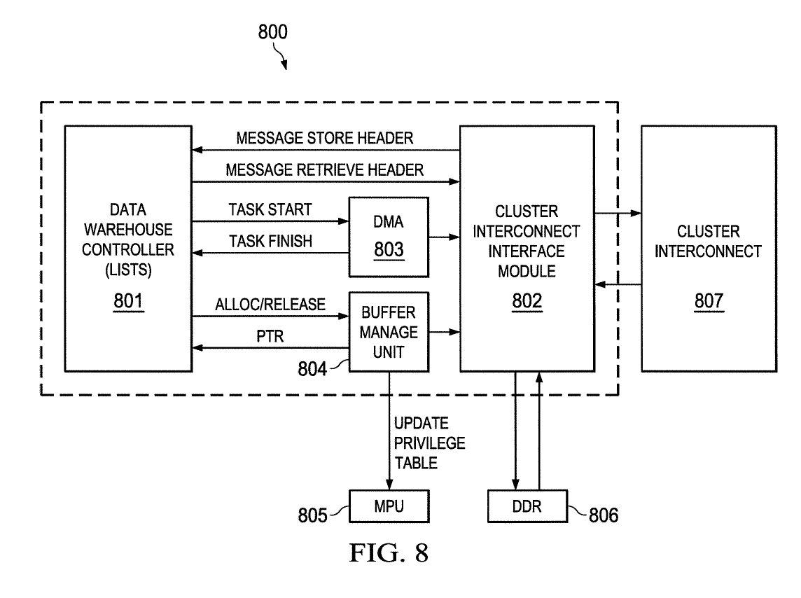

FIG. 8 illustrates an example data warehouse architecture in accordance with this disclosure. The data warehouse 800 could represent any of the data warehouses described in FIGS. 1 through 7B. Of course, the data warehouse 800 could also be used in any other suitable system.

As shown in FIG. 8, the data warehouse 800 includes a data warehouse controller 801, a cluster interconnect interface module 802, a direct memory access (DMA) module 803, a buffer management unit 804, and a memory protection unit (MPU) 805. The data warehouse 800 is coupled to at least one DDR memory 806 and a cluster interconnect 807. In some embodiments, the various components of the data warehouse 800 are disposed on one substrate or chip. The data warehouse 800 allows bulk memory to receive and transmit messages as well as the DSP and HAC clusters.

The data warehouse controller 801 manages the input and output of data stored in the DDR memory 806. To optimize the processing, the data warehouse controller 801 programs the DMA 803 to accelerate the movement of data to and from the DDR memory 806. The data warehouse controller 801 can include one or more tables or lists that link boxes of data by users, subframe, or any other logical entity. Data is physically stored in the DDR memory 806 using one or more dynamic buffer management algorithms.

The buffer management unit 805, under control of the data warehouse controller 801, allocates and frees data buffers in the DDR memory 806 so that the memory can be used and reused as required. The cluster interconnect 807 is an interconnect to the remaining portions of the DSP or HAC cluster or the SoC. The cluster interconnect interface module 802 provides a connection between the data warehouse 800 and the DDR memory 806, and provides a connection between the data warehouse 800 and the cluster interconnect 807.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A data warehouse, comprising:
a memory disposed on a substrate associated with a System on Chip (SoC); and
a controller disposed on the substrate and operatively coupled to the memory, the controller configured to:
receive data from a first intellectual property (IP) block executing on the SoC;
store the data in the memory; and
in response to a trigger condition, output at least a portion of the stored data to the SoC for use by a second IP block,
wherein an organization scheme for the stored data in the memory is abstracted with respect to the first and second IP blocks.

2. The data warehouse of claim 1, wherein the memory comprises at least one of double data rate (DDR) memory or bulk on-chip memory.

3. The data warehouse of claim 2, wherein the data comprises Hybrid Automatic Repeat Request (HARQ) data.

4. The data warehouse of claim 3, wherein the HARQ data is arranged in the DDR memory by subframe and user.

5. The data warehouse of claim 4, wherein the organization scheme comprises at least one user table, the at least one user table comprising a number of allocated buffers for each user or a buffer number of a starting buffer for each user.

6. The data warehouse of claim 1, wherein the trigger condition is one of: a data request from the second IP block, back pressure, or a lack of space in the memory to store new received data.

7. The data warehouse of claim 1, wherein the portion of the stored data is output to a memory associated with a digital signal processor (DSP) cluster.

8. The data warehouse of claim 1, wherein:
the memory comprises a transfer queue and the data is received from a source queue; and
outputting the at least portion of the stored data comprises outputting a first portion of the stored data to a destination queue, receiving an indication that the destination queue has available space, and outputting a second portion of the stored data to the destination queue.

9. The data warehouse of claim 1, wherein the first IP block and the second IP block are the same IP block.

10. The data warehouse of claim 1, wherein the controller is configured to determine the organization scheme for the stored data based on a data type of the received data.

11. A method, comprising:
receiving, by a controller of a data warehouse, data from a first intellectual property (IP) block executing on a System on Chip (SoC), the controller disposed on a substrate associated with the SoC;
storing, by the controller, the data in a memory disposed on the substrate, the memory operatively coupled to the controller; and
in response to a trigger condition, outputting, by the controller, at least a portion of the stored data to the SoC for use by a second IP block,
wherein an organization scheme for the stored data in the memory is abstracted with respect to the first and second IP blocks.

12. The method of claim 11, wherein the memory comprises at least one of double data rate (DDR) memory or bulk on-chip memory.

13. The method of claim 12, wherein the data comprises Hybrid Automatic Repeat Request (HARQ) data.

14. The method of claim 13, wherein the HARQ data is arranged in the DDR memory by subframe and user.

15. The method of claim 14, wherein the organization scheme comprises at least one user table, the at least one user table comprising a number of allocated buffers for each user or a buffer number of a starting buffer for each user.

16. The method of claim 11, wherein the trigger condition is one of: a data request from the second IP block, back pressure, or a lack of space in the memory to store new received data.

17. The method of claim 11, wherein the portion of the stored data is output to a memory associated with a digital signal processor (DSP) cluster.

18. The method of claim 11, wherein:
the memory comprises a transfer queue and the data is received from a source queue; and
outputting the at least portion of the stored data comprises outputting a first portion of the stored data to a destination queue, receiving an indication that the destination queue has available space, and outputting a second portion of the stored data to the destination queue.

19. The method of claim 11, wherein the first IP block and the second IP block are the same IP block.

20. The method of claim 11, further comprising:
determining the organization scheme for the stored data based on a data type of the received data.
